(19) United States
(12) Patent Application Publication
(10) Pub. No.: US 2005/0088621 A1
(43) Pub. Date: Apr. 28, 2005

(54) Projector

(75) Inventor: Hajime Ikeuchi, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/939,596

(22) Filed: Sep. 14, 2004

(30) Foreign Application Priority Data
Sep. 18, 2003 (JP) 2003-326300

(51) Int. Cl. G03B 31/00

(52) U.S. Cl. 353/15

(57) ABSTRACT

A projector is provided that plays recording mediums, such as DVD and video tapes, which switches between a projection image to another image by stopping or suspending playback, or starting a playback or recording operation. In S205, whether a break switch is depressed during image playback in S203 is judged. When the break switch is depressed, the flow proceeds to S206. When the break switch is not depressed, the condition in S203 is continued. In S206, an image playback portion suspends playing the recording medium. The image is suspended at one scene and so is the playback of sounds. Also, a CPU issues a command to a time measuring portion to measure a suspend time, according to a signal obtained when the break switch is depressed. The time measuring data is saved successively in a RAM. In S207, image data of a guiding image in a data storage portion in a ROM or an EEPROM is read out, and the image suspended by the image playback portion is switched to the image data of the guiding image to be displayed.

### BACKGROUND OF THE INVENTION

1. Field of Invention

Exemplary aspects of the present invention relate to a projector including an image playback portion to play a recording medium, such as a DVD (Digital Versatile Disc), and a projection portion to project a played back image, which are combined in one unit.

2. Description of Related Art

A related art projector projects an image on a screen, or the like, and can be used in a home theater or the like.

The use in a home theater or the like may involve connecting a separately installed DVD player and projector through a wire or the like. Image data and sound data played back by the DVD player are sent to the projector via the wire, thereby enabling the projector to project an image on the screen or the like and the speaker to output sounds. See JP-A-2002-290877 (pp. 5-7, FIG. 2 through FIG. 4).

The related art also includes a device capable of displaying a high-quality still image when a video tape being played by a VTR (Video Tape Recorder) is suspended. See JP-A-11-331754 (p. 6, FIG. 1).

### SUMMARY OF THE INVENTION

The time needed to play back and view images, such as a movie, recorded in a DVD or the like can be as long as six hours. Hence, the viewer may take a bathroom break, a coffee break, etc. while he is watching a movie or the like. Also, the viewer may watch a movie or the like with the room light turned OFF.

In a case where the viewer wishes to take a bathroom break or the like during the viewing while he is watching a movie or the like in the home theater, he has to press the pause button of the image playback device that plays a recording medium, such as a DVD and a video tape, and turn ON the light. In a case where the viewer suspends the image playback device to take a short break, in the related art a suspended image continues to be displayed on the screen, and the viewer is not able to take a break comfortably. In addition, when the image playback device is suspended, the sounds are halted as well, which does not provide a suitable environment for taking a break.

Also, in a case where the light is OFF when the viewer wishes to resume the playback by the image playback device after the break, the playback button is hard to see and he may press another button by mistake. When the button pressed by mistake is the stop button, the recording medium has to be played from the start, and the viewer, wishing to watch the rest of the movie or the like, has to find where he suspended the playback, through manipulations, such as fast-forwarding.

Exemplary aspects of the present invention address the above and/or other problems, and provide a projector combined in one unit with an image playback portion to play a recording medium, such as a DVD and a video tape, which, in response to a predetermined manipulation, suspends the playback by the image playback portion and switches a projection image to be projected from a projection portion in the projector to another image.

In order to address and/or solve the above and/or other problems, exemplary aspects of the invention include: an image playback portion to play back an image recorded in a recording medium; a projection portion to project the image played back by the image playback portion; a manipulation portion to stop or start image playback by the image playback portion; a data storage portion to store image data of a guiding image indicating that the image playback is being stopped; and a control portion to stop the image playback by the image playback portion according to a stop signal provided when the manipulation portion is manipulated, and to project the guiding image, indicating a stopped condition, from the projection portion according to the image data read out from the data storage portion.

It is thus possible to stop the image playback by the image playback portion when the manipulation portion is manipulated while the image playback portion is playing back images recorded in a recording medium and the images being played back by the image playback portion are projected, as well as to project a guiding image indicating a stopped condition. The viewer is thus able to take a break comfortably.

According to the projector of an exemplary aspect the invention, the control portion projects the guiding image at predetermined brightness to serve also as pre-set lighting.

Because the guiding image is projected at predetermined brightness to serve also as the pre-set lighting, when the viewer stops the image playback portion by manipulating the manipulation portion while he is watching videos in a dimly lit room, the brightness of the guiding image eliminates the need to turn on the room light.

According to the projector of an exemplary aspect of the invention, the guiding image includes a text or a picture indicating the stopped condition. More than one item of moving picture data to change conditions of the text or the picture is stored in the data storage portion. The control portion projects the guiding image from the projection portion, by changing the conditions of the text or the picture according to the moving picture data read out from the data storage portion.

Because the guiding image includes the text or the picture indicating the stopped condition, it is possible to notify the viewer watching the videos that the playback by the image playback portion is now being stopped. Also, by changing the conditions of the text or the picture according to the moving picture data, the guiding image is able to notify the viewer that the projector, including the image playback portion, is operating normally. Further, by storing more than one guiding image containing the moving picture data in the data storage portion, the viewer of the videos is able to select the guiding image of his taste.

According to the projector of an exemplary aspect of the invention, a speaker is further included, and the control portion outputs predetermined sounds from the speaker while the guiding image is being projected from the projection portion.

By outputting predetermined sounds from the speaker while the guiding image is displayed, the viewer is able to take a break in a more comfortable condition.

According to the projector of an exemplary aspect of the invention, the guiding image includes a text or a picture to instruct a procedure to start the playback by the image playback portion. By including the text or the picture to instruct the procedure to start the playback by the image playback portion, the guiding image is able to notify the viewer of the procedure to start the image playback in the form of the text or the picture, so that he is able to start the image playback in a reliable manner.

According to the projector of an exemplary aspect of the invention, the manipulation portion includes a light emitting portion, and the control portion causes the light emitting portion in the manipulation portion to light ON or flash when the stop signal is provided.

When the stop signal is provided, the control portion causes the light emitting portion in the manipulation portion to light ON or flash. This makes it easier for the viewer to manipulate the manipulation portion when he starts the playback by the image playback portion even when he is watching videos in a dimly lit room.

According to the projector of an exemplary aspect of the invention, a lighting portion to emit light from a portion other than a projection lens portion of the projection portion is further included. The control portion causes the lighting portion to emit light when the stop signal is provided.

When the image playback portion is stopped by manipulating the manipulation portion, light is emitted from the lighting portion provided besides the projection lens portion in the projection portion. Thus, when the viewer is watching videos in a dimly lit room, he is able to take a break with the lighting from the lighting portion without having to turn ON the room light.

According to the projector of an exemplary aspect of the invention, when a playback start signal is provided by a manipulation on the manipulation portion, the control portion causes the image playback portion to start the image playback, and switches the guiding image being projected from the projection portion to a playback image of the image playback portion.

When the image playback by the image playback portion is started by manipulating the manipulation portion, the guiding image being projected from the projection portion is switched to the playback image of the image playback portion. The viewer is thus able to continue to watch the rest of videos with ease.

According to the projector of an exemplary aspect of the invention, when the playback start signal is provided, the control portion causes the image playback portion to start the image playback from an image at least earlier than an image when the image playback was stopped.

By starting the image playback from an image at least earlier than the image when the playback was stopped, the viewer is able to immediately recall the story of the movie or the like before the break, and therefore enjoy the rest of the movie or the like.

### BRIEF DESCRIPTION OF THE DRAWINGS

FIG. 1 is a schematic of a projector according to a first exemplary embodiment;

FIG. 2 is a schematic of a manipulation portion provided to a projection portion main body;

FIG. 3(a) is a schematic explaining a manner to project an image on a screen using the projector in a room, and FIG. 3(b) is a schematic of a guiding image;

FIG. 4 is a schematic of a ceiling lighting portion and an indirect lighting portion;

FIG. 5 is an a schematic of a notifying image;

FIG. 6 is a schematic of the projector;

FIG. 7 is a schematic of a spring pin;

FIG. 8 is a schematic showing the electrical configuration of the projector;

FIG. 9 is a flowchart of a program of the projector;

FIG. 10 is a schematic of a projector according to a second exemplary embodiment;

FIG. 11 is a schematic of a display portion; and

FIG. 12 is a schematic showing the electrical configuration of the projector.

### DETAILED DESCRIPTION OF EXEMPLARY EMBODIMENTS

Exemplary aspects of the invention will now be described with reference to the accompanying drawings in a case where the exemplary aspects of the invention are applied to a projector with a DVD player, a video tape recorder, a video camera, a camera with a built-in DVD, etc. by way of example. It should be appreciated, however, that the exemplary embodiments below are not for the purpose of limitation of the invention. Also, not all the configurations described in the exemplary embodiments below are essential.

First Exemplary Embodiment

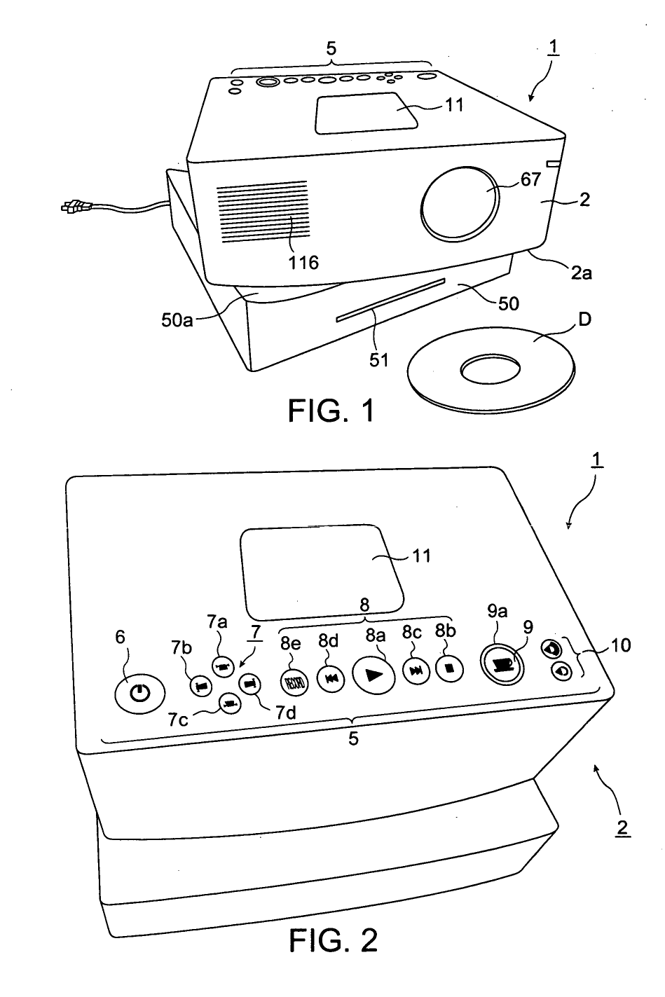

A first exemplary embodiment as a concrete form of the invention will now be described with reference to FIG. 1 through FIG. 9.

FIG. 1 is a schematic of a projector according to the first exemplary embodiment. Referring to FIG. 1, in a projector 1, a projection portion main body 2 is placed on the top surface of an image playback portion main body 50 so as to be allowed to tilt. The image playback portion main body 50 includes a concave spherical surface serving as a guiding surface 50a, which is allowed to tilt with respect to a convex spherical surface serving as a guiding surface 2a provided at the lower portion of the projection portion main body 2. The image playback portion main body 50 has a slot 51 to insert or remove a recording medium D, such as a DVD, having recorded images or sounds. The projection portion main body 2 includes a projection lens portion 67, speakers 116, a manipulation portion 5, a lamp cover 11, etc. The projection lens portion 67 is furnished with a function of zooming up or down and focusing an image when the image is projected on the screen (not shown) or the like. The speakers 116 output sounds played back from the recording medium D inserted in the image playback main body 50 for the viewer to hear them as music, voices, or artificial sounds. The manipulation portion 5 includes a plurality of switches to manipulate the projection portion and the image playback portion in various manners.

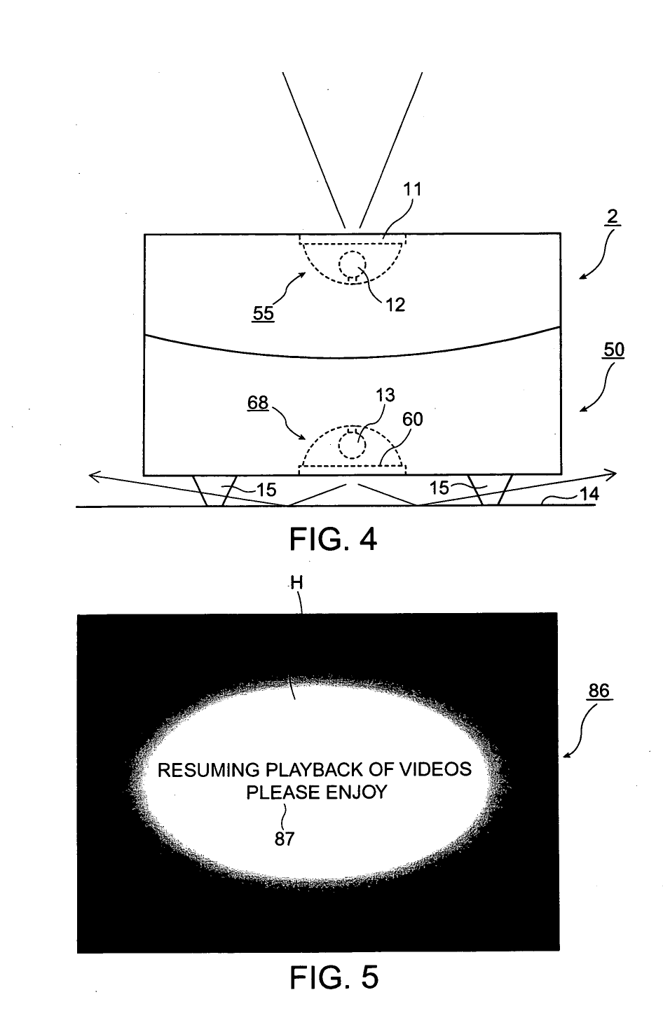

FIG. 2 is a schematic of the manipulation portion provided to the projection portion main body. As is shown in FIG. 2, the manipulation portion 5 provided to the projection portion main body 2 includes a power switch 6 to turn on the power of the projector 1, a keystone switch 7 (for example, it includes four switches, 7a, 7b, 7c, and 7d in this exemplary embodiment) to correct a deformation in shape of a image (image plane) projected on the screen or the like from the projection lens portion 67, a playback switch 8, a break switch 9 for a break, and a volume switch 10 to adjust the volume of the speakers 116. The playback switch 8 includes a playback switch 8a to start the playback by the image playback portion, a stop switch 8b to stop the playback, a fast-forwarding switch 8c to fast-forward playback tracks in the recording medium D, a fast-winding switch 8d to fast-wind the playback tracks, and a record switch 8e to record an image or sounds in the recording medium D. Also, in close proximity to the break switch 9 is provided a light emitting portion 9a to light ON or flash when the break switch 9 is depressed. On the top surface of the projection portion main body 2 is provided a lamp cover 11 for a ceiling lighting portion 55 that lights ON when the image playback is suspended. Likewise, an indirect lighting portion 68 (see FIG. 4) is provided to the lower surface of the image playback portion main body 50.

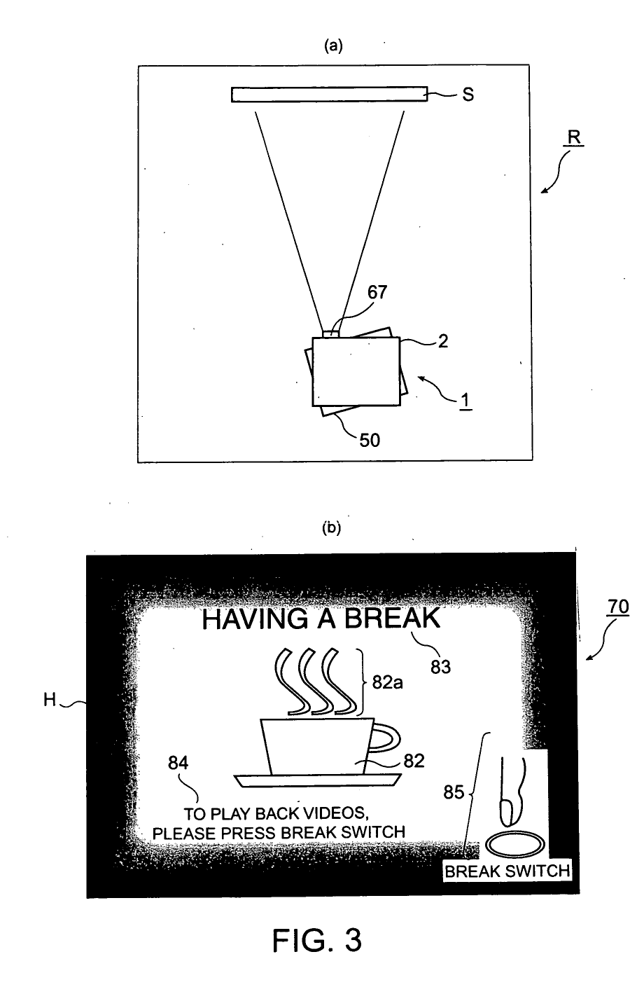

FIG. 3(a) is a schematic to explain a manner by which an image is projected on a screen using a projector in a room. FIG. 3(a) shows a case where the projector 1 is installed in a room R, and the viewer (not shown) is watching a movie or the like on a screen S by inserting the recording medium D into the slot 51 of the image playback portion main body 50, as is shown in FIG. 1, and manipulating the playback switch 8 in the manipulation portion 5. With the projector 1, the projection portion main body 2 is tilted with respect to the image playback portion main body 50 in projecting a played back image from the projection lens portion 67 on the screen S. In this manner, the projector 1 is configured to set the projection portion main body 2 in an arbitrary direction with respect to the image playback portion main body 50. Hence, when the position of the screen S is moved to another position in the room R, the projector 1 does not have to be moved entirely. Instead, the direction of projection light to be projected from the projection lens portion 67 can be readily changed by merely tilting the projection portion main body 2 with respect to the image playback portion main body 50.

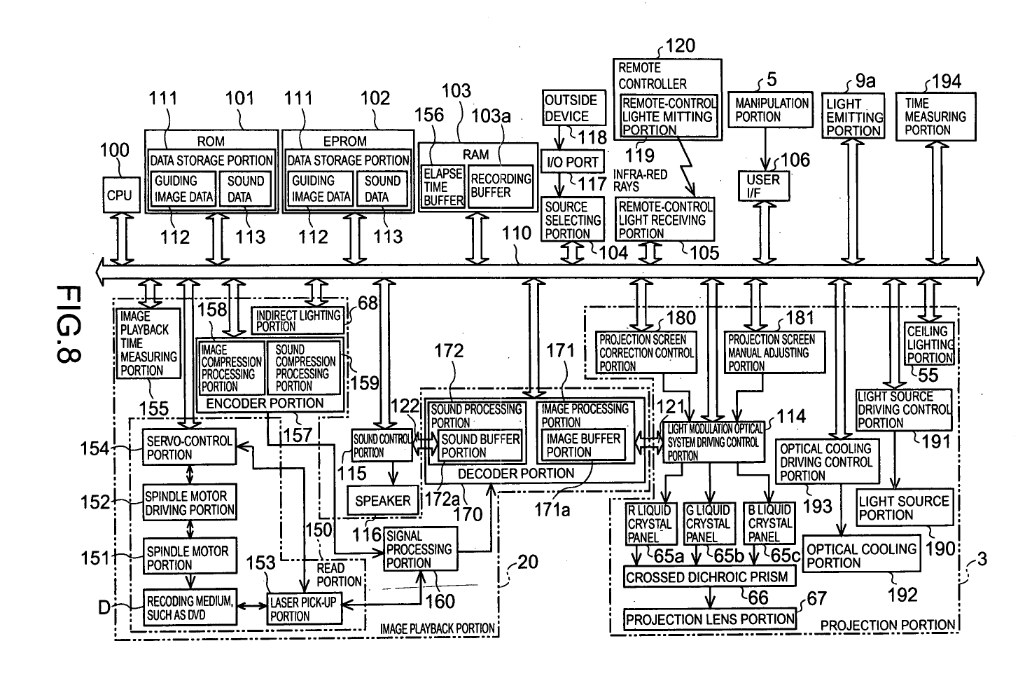

FIG. 3(b) is a schematic of a guiding image. When the break switch 9 in the manipulation portion 5 is depressed, the playback of images is suspended, and the image to be projected is switched to an image (hereinafter, guiding image) 70 pre-stored in a data storage portion 111 (see FIG. 8). The guiding image 70, for example, includes, on a projection background H, a picture 82 showing a “coffee cup” as a picture indicating a break, which is projected together with the projection background H as one image. The projection background H, also serving as lighting of the room, is set to predetermined brightness, color saturation, and hue set in advance. The brightness or the color saturation is not necessarily the maximum brightness or color saturation of the projection portion main body 2, and can be as high as or lower than the maximum brightness or color saturation provided that brightness sufficient to also serve as the lighting of the room can be achieved. On the periphery of the guiding image 70 is provided a portion in which the brightness or the color saturation is varied gradually in comparison with the projection background H. It should be appreciated, however, that the projection background H alone may be used.

On the guiding image 70 is projected a text 83, “Having a break”, to indicate that presently a break is being taken. Also, a text (“To play back videos, please press break switch” in this exemplary embodiment) 84 instructing the procedure to play back images or a picture 85 instructing to press the break switch 9 is projected for the viewer wishing to watch the rest of the movie after the break. Also, in the picture 82 indicating the “coffee cup”, a portion indicating steams 82a may be a moving picture, so that the portion of the steams 82a may be varied as if steams were rising up from the coffee cup. Alternatively, for the picture 82, an image of the moving picture may be combined with the projection background H in the form of data (so-called pasted data), so that the moving picture is enabled on the projection background H.

As has been described, the guiding image 70 may include the one including still image data alone, the one including still image data combined with moving picture data, and the one including moving picture data alone. These items of data forming the guiding image 70 are stored in the data storage portion 111 (see FIG. 8) in a ROM 101 or an EEPROM 102 as a data file. When the break switch 9 in the manipulation portion 5 is depressed, a CPU 100 (see FIG. 8) suspends the playback of images, reads out the guiding image 70 from the data storage portion 111, and thereby switches an image to be projected from the played back image to the guiding image 70.

The moving picture data referred to herein means data capable of changing a currently displayed condition by displaying more than one item of image data continuously according to the basic software (hereinafter, OS (Operating System)) and various application programs pre-stored in the ROM 101 or the EEPROM 102 in the projector 1. It is thus possible to use the image data generated with the use of a video recorder, a DVD, graphic designs, etc. for the guiding image 70, either entirely or partially. Alternatively, the conditions of the text 83 and the text 84 may be changed to be displayed in rotating, moving, or flashing conditions. They may be displayed in combination of these conditions. Also, when the break switch 9 in the manipulation portion 5 shown in FIG. 2 is depressed, the light emitting portion 9a provided in close proximity to the switch lights ON or flashes in notifying the viewer that the playback of images can be resumed by depressing the break switch 9 when he wishes to watch the rest of the movie or the like after the break.

FIG. 4 is a schematic of the ceiling lighting portion and the indirect lighting portion. Referring to FIG. 4, when the break switch 9 in the manipulation portion 5 is depressed, the CPU 100 (see FIG. 8) suspends the playback of images, and causes at least one of a ceiling illuminating lamp 12 in the ceiling lighting portion 55 provided to the projection portion main body 2 and an indirect illuminating lamp 13 in the indirect lighting portion 68 provided to the image playback portion main body 50 to light ON in serving as the lighting of the room where the viewer is watching the movie or the like. The inside of the lamp cover 11 of the ceiling lighting portion 55 is ground-glass. While the ceiling illuminating lamp 12 legs 15 are provided at the lower portion of the image playback portion main body 50 to secure a space from a mount table 14. Lighting light coming out from the indirect illuminating lamp 13 in the indirect lighting portion 68 thus illuminates the room indirectly by passing through a lamp cover 60 and being reflected on the mount table 14, and thereby serves as indirect lighting.

FIG. 5 is a schematic view of a notifying image. In a case where the break switch 9 is depressed again while the playback of images by the image playback portion is suspended in response to the depressing of the break switch 9, the guiding image 70 being displayed up to this moment is switched to a notifying image 86 indicating that the playback of images is to be resumed, in the form of a text or a picture. In this exemplary embodiment, a text indicating that the playback is resumed, “Resuming playback of videos. Please enjoy.”, will be displayed as a text 87, in notifying the viewer of the resumption of the playback. Alternatively, the same can be notified in the form of a picture. In this case, the projection background H portion may lower the brightness or color saturation step by step, so that the notifying image 86 is switched to a playback image of the image playback portion 20 (shown in FIG. 8) when the predetermined darkness is achieved. Also, the guiding image 70 may be switched directly to the playback image without displaying the notifying image 86.

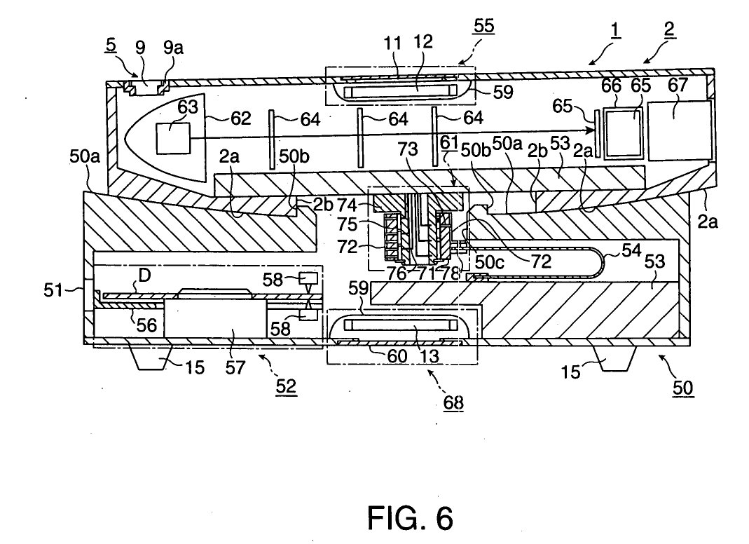

FIG. 6 is a schematic of the projector. The projection portion main body 2 is provided on the top surface of the image playback main body 50 so as to be allowed to tilt. In the image playback portion main body 50, the guiding surface 50a including a concave spherical surface engages with the guiding surface 2a including a convex spherical surface provided at the lower portion of the projection portion main body 2. With respect to the image playback portion main body 50, the projection portion main body 2 is allowed to move in any direction and rotate where it has moved. Moreover, it is allowed to tilt.

To tilt the projection portion main body 2 with respect to the image playback portion main body 50 in the projector 1, the projection portion main body 2 is pushed or pulled in a desired tilting direction. The guiding surface 2a including the convex spherical surface of the projection portion main body 2 slides on the guiding surface 50a including the concave spherical surface of the image playback portion main body 50, and a hole portion 2b of the projection portion main body 2 comes in contact with a wall portion 50b of the image playback portion main body 50. In this case, a rotary connector portion 61 is provided so as not to come in contact with a central hole portion 50c in the image playback portion main body 50.

The cases of the projection portion main body 2 and the image playback portion main body 50 are made of light metals having satisfactory heat conductivity, such as aluminum, magnesium, and titanium, or alloy of the foregoing, or resins, such as polycarbonate containing carbon fillers, polyphenylene sulfide, and liquid crystal resin. A treatment is applied to the guiding surface 50a including the concave spherical surface and the guiding surface 2a including the convex spherical surface, such as silicon-based resin film coating treatment, to reduce the frictional coefficient. A tilting load between the projection portion main body 2 and the image playback portion main body 50 is thereby reduced. A plurality of legs 15 are made of rubber, silicon-based rubber, or silicon-based plastic, to make it difficult for the image playback portion main body 50 to slide on the mount table (not shown).

As has been described, because the projection portion main body 2 is allowed to tilt with respect to the image playback portion main body 50, they are together able to project an image on the screen (not shown) or the like in a desired direction at a desired angle as the projector 1 that scales-up and projects a color image by the projection lens portion 67.

The image playback portion main body 50 includes at least a read portion 52 to read out images or sounds recorded in the recording medium D inserted therein, an electric circuit portion 53 to control the projector 1, a cable 54 to electrically connect the image playback portion main body 50 and the projection portion main body 2, the indirect lighting portion 68, a plurality of legs 15, etc.

In the read portion 52, a disc tray 56 is projected outward from the image playback portion main body 50, and after the recording medium D is placed on the disc tray 56, the recording medium D is set in a spindle motor 57 by activating a disc loading mechanism (not shown). Image data or sound data recorded in the recording medium D is read out by a laser pick-up 58. The image data or sound data thus read out is sent to the projection portion main body 2 via the electric circuit portion 53 and the cable 54.

The indirect lighting portion 68 is provided with the indirect illuminating lamp 13. When the indirect illuminating lamp 13 is lit, light from the indirect illuminating lamp 13 passes through the lamp cover 60 provided at the lower portion of the image playback portion main body 50 by a reflection plate 59 to go outside of the projector 1.

When the indirect illuminating lamp 13 is lit, the light goes out to the room where the projector 1 is installed through a space, secured from the mount table (not shown) by a plurality of legs 15 provided at the foot of the projector 1, and thereby serves as the room light.

The projection portion main body 2 includes at least the rotary connector portion 61, an optical system from the light source portion 62 to the projection lens portion 67, the electric circuit portion 53, the ceiling lighting portion 55, the manipulation portion 5, etc.

Image data or sound data sent from the image playback portion main body 50 is sent to the projection portion main body 2 via the cable 54. As has been described, because the projection portion main body 2 is allowed to tilt with respect to the image playback portion main body 50, the former electrically responds to the latter. A displacement in the vertical direction between the projection portion main body 2 and the image playback portion main body 50 associated with the tilting is accommodated by flexibility of the cable 54. Also, a displacement in a rotational direction between the projection portion main body 2 and the image playback portion main body 50 associated with the tilting is accommodated by the rotary connector portion 61.

In the rotary connector portion 61, a plurality of electrodes provided to the cable 54 are electrically connected to a plurality of connection pins 78 corresponding to the respective electrodes. The connection pins 78 are electrically bonded to a plurality of electrodes in a flexible substrate 72 provided on the periphery of a rotational body 71. Spring pins 73 are electrically bonded to the plurality of electrodes in the flexible substrate 72, respectively. Each spring pin 73 includes an outer cylinder portion fixed to the rotational body 71, a movable pin allowed to move inside the outer cylinder portion, and a coil spring or plate spring that presses the movable pin against the outer cylinder portion. The movable pin is electrically connected to the outer cylinder portion via the coil spring or the plate spring. The movable pin is pressed by a spring force induced from the coil spring or the plate spring and is thereby electrically connected to a stationary electrode 75 provided to a stationary portion 74. Because a plurality of stationary electrodes 75 form independent electrodes on the outer periphery of the stationary body 74, each spring pin 73 is electrically connected to any corresponding one of the stationary electrodes 75 on the circumference.

The plurality of stationary electrodes 75 are electrically bonded to connection lines 76, to the outer peripheries of which is applied the electric insulating treatment, and are thereby bonded to the electric circuit portion 53.

These configurations enable the projection portion main body 2 to tilt with respect to the image playback portion main body 50.

The optical system from the light source portion 62 to the projection lens portion 67 separates a flux of light emitted from a light source lamp 63 in the light source portion 62 to beams of color light for three primary colors, red, green, and blue, by a color separation optical system using a dichroic mirror 64 or the like. The separated beams of color light are modulated according to image information in three light modulation devices using an R (red) liquid crystal panel 65a, a G (green) liquid crystal panel 65b, and B (blue) liquid crystal panel 65c, respectively. Image-modulated respective beams of color light are then synthesized in a crossed dichroic prism 66, and a color image is scaled up and projected by the projection lens portion 67. In short, a so-called triple-plate projector is achieved.

The ceiling lighting portion 55 is provided with the ceiling illuminating lamp 12. In a case where the break switch 9 in the manipulation portion 5 is depressed, the playback of images by the image playback portion is suspended and the ceiling illuminating lamp 12 is lit. Light from the ceiling illuminating lamp 12 passes through the lamp cover 11 provided to the upper portion of the projection portion main body 2 by the reflection plate 59 to go outside of the projector 1. The light thereby serves as the room light. The inside of the lamp cover 11 is ground-glass so that the ceiling illuminating lamp 12 inside is invisible while the ceiling illuminating lamp 12 stays OFF. The lamp cover 11 is made of light-transmitting materials, such as glass and plastic.

The manipulation portion 5 includes at least the break switch 9 and the light emitting portion 9a, and is attached to the case of the projection portion main body 2. The break switch 9 is electrically connected to the electric circuit portion 53. Thus, when the break switch 9 is depressed, a signal obtained from the break switch 9 is sent to the electric circuit portion 53, and the electric circuit portion 53 causes the light emitting portion 9a to light ON or flash. The configuration of the electric circuit portion 53 will be described in detail with reference to FIG. 8.

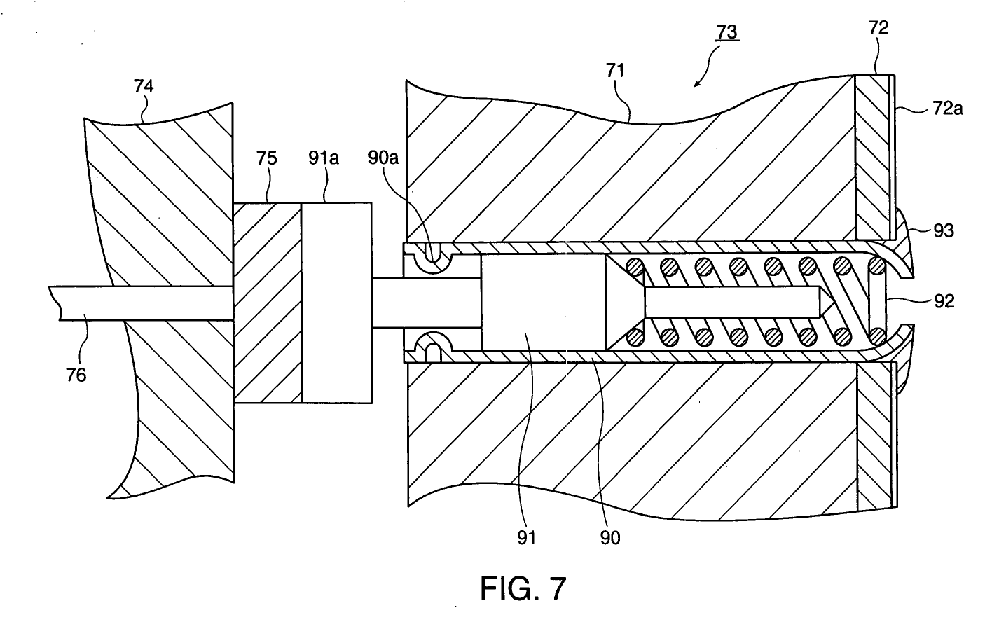

FIG. 7 is a schematic of the spring pin. The spring pin 73 includes an outer cylinder 90 fixed to the rotational body 71, a movable pin 91 allowed to move inside the outer cylinder 90, and a coil spring 92 to press the movable pin 91. The coil spring 92 is incorporated inside the outer cylinder portion 90, and an aperture portion 90a of the outer cylinder portion 90 is deformed while the movable pin 91 is kept pressed so the movable pin 91 does not fall off. Also, one end 91a of the movable pin 91 is electrically connected to the stationary electrode 75 fixed to the stationary body 74. The stationary electrode 75 is electrically connected to the connection line 76, to the outer periphery of which is applied the electric insulation treatment, and is thereby electrically connected to the electric circuit portion 53 (shown in FIG. 6) of the projection portion main body 2. The other end of the outer cylinder portion 90 is electrically connected to a pattern-molded electrode 72a of the flexible substrate 72 with the use of a solder 93. The movable pin 91 constantly presses the stationary electrode 75 with a force induced by bending the coil spring 92, so that the projection portion main body 2 is kept electrically connected to the image playback portion main body 50 even when the former is rotated with respect to the latter.

FIG. 8 is an electric configuration of the projector. The projector 1 includes the CPU (Central Processing Unit) 100 serving as a control portion, the ROM (Read Only Memory) 101, the EEPROM (Electrically Erasable Programmable Read Only Memory) 102, and a RAM (Random Access Memory) 103. It also includes a source selecting portion 104, a remote-control light receiving portion 105, a user interface (hereinafter, user I/F) 106, the image playback portion 20, the projection portion 3, a sound control portion 107, a time measuring portion 194, the indirect lighting portion 68, and the ceiling lighting portion 55, all of which are electrically interconnected via a data bus 110.

The CPU 100 executes various operations according to the control program or various application programs stored in the ROM 101 and the EEPROM 102. The EEPROM 102 is a ROM capable of electrically over-writing the contents of the control program and various application programs. The RAM 103 stores data or a program being processed, and includes an elapse time buffer 156 and a recording buffer 103a serving as a buffer for image data and sound data being recorded. When the power of the projector 1 is turned OFF, the contents in the memory of the RAM 103 are automatically erased.

The source selecting portion 104 establishes a connection to an outside device 118, such as a PC (Personal Computer), via an I/O port 117. Upon receipt of image data or sound data produced in the outside device 118 at the source selecting portion 104, the CPU 100 sends the image data to a light modulation optical system driving control portion 114. The image data is modulated according to image information for respective beams of color light by three light modulation devices using the R (red) liquid crystal panel 65a, the G (green) liquid crystal panel 65b, and the B (blue) liquid crystal panel 65c, respectively. The image-modulated respective beams of light are then synthesized in the crossed dichroic prism 66, and a color image is scaled up and projected by the projection lens portion 67. The CPU 100 sends the sound data to the sound control portion 115, and the sound control portion 115 applies the processing, such as amplification, to the sound data thus sent and converts the sound data to sound signals, which are sent to a plurality of speakers 116 for the viewer to hear them as sounds.

The remote-control light receiving portion 105 receives infra-red rays emitted from a remote-control light emitting portion 119 in the remote controller 120, and converts various commands contained in the receipt infra-red rays to signals, which are sent to the CPU 100. Upon reception of the signals, the CPU 100 executes the control program or various application programs.

The CPU 100 receives signals according to manipulations on respective switches 6 through 10 (shown in FIG. 2) provided in the manipulation portion 5 via the user I/F 106. The CPU 100 executes various types of processing according to the control program or various application programs by signals according to manipulations on the respective switches 6 through 10 provided in the manipulation portion 5.

The image playback portion 20 includes a read portion 150 to read out image data or sound data by rotating the recording medium D inserted therein, a signal processing portion 160 to convert analog signals read in the read portion 150 to digital signals through shaping, a decoder portion 170 to restore the digital signals obtained in the signal processing portion 160 to original codes according to prescribed rules, the indirect lighting portion 68, and an image playback time measuring portion 155. Also, it includes an encoder portion 157 to record image data or sound data in the recording medium D.

The read portion 150 includes a spindle motor portion 151 rotating with the recording medium D placed thereon, a spindle motor driving portion 152 to drive the spindle motor portion 151, a laser pick-up portion 153 to read out image data or sound data recorded in the recording medium D, and a servo-control portion 154 to effect the servo-control between the spindle motor portion 151 and the laser pick-up portion 153.

The decoder portion 170 includes an image processing portion 171 to restore image signals in the digital signals obtained in the signal processing portion 160 to original codes according to prescribed rules, and a sound processing portion 172 to restore sound signals in the digital signals obtained in the signal processing portion 160 to original codes according to prescribed rules. The data processed in the image processing portion 171 is temporarily stored in an image buffer portion 171a included in the image processing portion 171, and is then sent to the light modulation optical system driving control portion 114 via an image-exclusive data bus 121 in the first-in-first-out manner. The sound data processed in the sound processing portion 172 is temporarily stored in a sound buffer portion 172a included in the sound processing portion 172, and is then sent to the sound control portion 115 via a sound-exclusive data bus 122 in the first-in-first-out manner.

When the break switch 9 in the manipulation portion 5 is depressed, the CPU 100 causes the indirect lighting portion 68 to light ON. When the break switch 9 is depressed again, the CPU 100 stops the lighting.

The image playback time measuring portion 155 measures an elapse time of image playback in the read portion 150, and data as to the elapse time is stored successively in the elapse time buffer 156 in the RAM 103.

The encoder portion 157 includes an image compression processing portion 158 to encode (compress) image data sent via the data bus 110 when the record switch 8e in the manipulation portion 5 is depressed, and a sound compression processing portion 159 to encode (compress) sound data sent in the same manner. Data having undergone the compression processing in the encoder portion 157 is converted to a writing signal in the signal processing portion 160, and recorded in the recording medium D, such as a DVD.

The projection portion 3 includes the light modulation optical system driving control portion 114, the light modulation devices, the crossed dichroic prism 66, the projection lens portion 67, a projection image correction control portion 180, a projection image manual adjusting portion 181, a light source portion 190, a light source driving control portion 191, an optical cooling portion 192, an optical cooling driving control portion 193, a time measuring portion 194, and the ceiling lighting portion.

When the playback switch 8a of the playback switch 8 in the manipulation portion 5 is depressed, the laser pick-up portion 153 detects the presence or absence of the recording medium D. In the presence of the recording medium D, the read portion 150 is activated, and image data in the image processing portion 171 is stored temporarily in the image buffer portion 171a, which is then sent to the light modulation optical system driving control portion 114 via the image-exclusive data bus 121 in the first-in-first-out manner. The image data thus sent is modulated according to image information for respective beams of color light by three light modulation devices using the R (red) liquid crystal panel 65a, the G (green) liquid crystal panel 65b, and the B (blue) liquid crystal panel 65c, respectively. The image-modulated respective beams of color light are synthesized in the crossed dichroic prism 66, and a color image is scaled up and projected by the projection lens portion 67. Sound data read out from the recording medium D is stored temporarily in the sound buffer portion 172a in the sound processing portion 172, and is then sent to the sound control portion 115 via the sound-exclusive data bus 122 in the first-in-first-out manner. The sound control portion 115 applies the processing, such as amplification, to the sound data thus sent and converts the sound data to sound signals, which are sent to a plurality of speakers 116 for the viewer to hear them as sounds.

To the light modulation optical system driving control portion 114 are connected the projection image correction control portion 180 and the projection image manual adjusting portion 181 via the data bus 110. When an image is projected from the projection lens portion 67 on the screen S or the like, the image projected on the screen S is deformed due to the relative positions of the projection lens portion 67 and the screen S, and for this reason, the projection image correction control portion 180 is furnished with a deformation correcting function. With a signal obtained when the keystone switch 7 in the manipulation portion 5 is depressed, the CPU 100 corrects the projection image deformed due to the relative positions of the projection lens portion 67 and the screen S.

The projection image manual adjusting portion 181 is furnished with a function of manually adjusting the settings, such as the luminance, a contrast ratio, color adjustment, etc. of the projection image.

The light source portion 190 is supplied with power from the light source driving control potion 191, and the lamp (not shown) of the light source portion 190 emits light to supply the R (red) liquid crystal panel 65a, the G (green) liquid crystal panel 65b, and the B (blue) liquid crystal panel 65c with their respective fluxes of light.

The optical cooling portion 192 is driven under the control of the optical cooling driving control portion 193, and removes heat generated in the light source portion 190 by cooling. With a light-ON instructing signal provided when the power switch 6 in the manipulation portion 5 is depressed, the CPU 100 issues a command to the light source driving control portion 191 to supply the light source 190 with power, and also issues a command to the light cooling driving control portion 193 to drive the optical cooling portion 192. With a light-OFF instructing signal provided when the power switch 6 in the manipulation portion 5 is depressed, the light source driving control portion 191 stops a supply of power to the light source portion 190 and thereby turns OFF the lamp. In this case, however, the temperatures of the liquid crystal panels 65a through 65c are quite high, and the optical cooling portion 192 needs to keep cooling the liquid crystal panels 65a through 65c. The CPU 100 therefore detects a drop in temperature of the liquid crystal panels 65a through 65c to a sufficiently low level after a predetermined time, by a temperature detecting sensor (not shown), or a timer portion (not shown) furnished with a timer function, after which it issues a command to the optical cooling driving control portion 193 to deactivate.

The time measuring portion 194 starts to measure a suspend time upon receipt of a suspend signal for the image playback portion 20 generated when the break switch 9 in the manipulation portion 5 is depressed during the playback by the image playback portion 20. The time measuring data thus measured is saved successively in the RAM 103. A predetermined time duration for the suspend time (hereinafter, the predetermined suspend time), for example, 30 minutes, is incorporated in the control program or various application programs saved in the ROM 101 or the EEPROM 102. When the time measuring data measured in the time measuring portion 194 and saved in the RAM 103 exceeds the predetermined suspend time, the CPU 100 not only stops the image playback portion 20 from the suspended condition, but also lights OFF the light source portion 190. Further, upon detection of a drop in temperature of the liquid crystal panels 65a, 65b, and 65c to a sufficiently low level after a predetermined time, by a temperature detecting sensor (not shown), or a timer portion (not shown) furnished with the timer function, the CPU 100 stops the optical cooling portion 192 and stops the projection portion 3, too. In a case where the viewer falls asleep while he was taking a break during movie viewing, in order to avoid an event that the image playback portion 20 and the projection portion 3 keeps operating unless a stop manipulation is performed, the CPU 100 automatically stops the image playback portion 20 and the projection portion 3 when the suspend time exceeds the predetermined suspend time.

The ROM 101 or the EEPROM 102 includes the data storage portion 111 storing image data 112 and sound data 113 of the guiding image. When the break switch 9 in the manipulation portion 5 is depressed while the image playback portion 20 is playing back images, the CPU 100 receives a signal from the break switch 9. Upon receipt of the signal, the CPU 100 suspends the image playback portion 20, and at the same time reads out the image data 112 of the guiding image in the data storage portion 111 in the ROM 101 or the EEPROM 102. The CPU 100 issues a command to the light modulation optical system driving control portion 114 to switch an image to the image data 112 of the guiding image thus read out. When the break switch 9 is depressed while the image playback portion 20 is playing back images, the image playback portion 20 is suspended, while an image to be projected from the projection lens portion 67 in the projection portion 3 is switched from an image being played back from the recording medium D to the image data 112 of the guiding image.

Also, when the break switch 9 is depressed while the image playback portion 20 is playing back images, the CPU 100 reads out the sound data 113 in the data storage portion 111 in the ROM 101 or the EEPROM 102 to provide the sound control portion 115 with the sound data 113 for the sounds to be outputted from the speakers 116. When the break switch 9 is depressed, the image playback portion 20 is suspended, and so is the played back sound from the recording medium D. In this exemplary embodiment, when the break switch 9 is depressed, sounds according to sound data pre-stored in the data storage portion 111 are output from the speaker 116 for the viewer to take a break comfortably. Also, when the break switch 9 is depressed while the image playback portion 20 is playing back images, the CPU 100 causes the light emitting portion 9a provided in close proximity to the break switch 9 to light ON or flash. In this case, the CPU 100 may cause the light emitting portion 9a to flash in such a manner that the flashing is in sync with the playback rhythm of the sound data 113.

The indirect lighting portion 68 and the ceiling lighting portion 55 are provided to the image playback portion 20 and the projection portion 3, respectively. When the CPU 100 receives the suspend signal obtained in response to the depressing of the break switch 9 in the manipulation portion 5 during the playback by the image playback portion 20, the CPU 100 turns ON the lighting in at least one of the indirect lighting portion 68 and the ceiling lighting portion 55 provided to the image playback portion 20 and the projection portion 3, respectively.

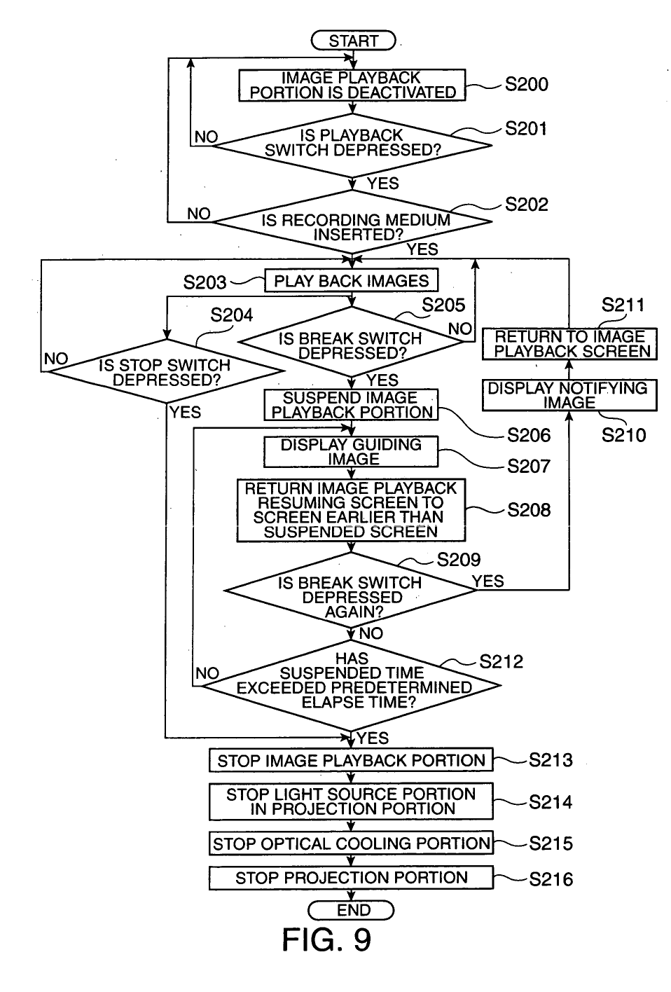

FIG. 9 is a flowchart of the program of the projector. Hereinafter, the processing contents that the CPU 100 executes from the condition in which the image playback portion is deactivated will be described.

Initially, in Step (hereinafter, abbreviated simply to S) 200, the CPU 100 executes the program according to signals obtained from the manipulations on various switches in the manipulation portion 5. In S201, whether the playback switch 8a in the manipulation portion 5 to start to play back images in the recording medium D is depressed is judged. When the playback switch 8a has been depressed, the CPU 100 receives a signal obtained when the playback switch 8a in the manipulation potion 5 is depressed, and proceeds to S202 by judging that the playback of images by the image playback portion 20 is to be started. When the playback switch 8a in the manipulation portion 5 has not been depressed, no image is played back and the condition in S200, where the image playback portion is deactivated, is continued.

In S202, whether the recording medium D is inserted in the image playback portion 20 is judged. The CPU 100 proceeds to S203 when the recording medium D has been inserted in the image playback portion 20. When the recording medium D has not been inserted in the image playback portion 20, the condition S200, where the image playback portion is deactivated, is continued.

In S203, an image signal from the recording medium D, which is now played back in the image playback portion 20, is sent to the projection portion 3 via the image-exclusive data bus 121, for a color image to be scaled up and projected on the screen S or the like from the projection lens portion 67 by way of the light modulation optical system driving control portion 114, the light modulation devices, and the crossed dichroic prism 66. Also, sound signals, which are now played back in the image playback portion 20, are sent to the sound control portion 115 via the sound-exclusive data bus 122, and subjected to the processing described above for the viewer to hear them as sounds from the speakers 116.

In Step 204, whether the stop switch 8b is depressed during the image playback in S203 is judged. When the stop switch 8b has been depressed, the step proceeds to S212. When the stop switch 8b has not been depressed, the condition in S203 is continued.

In S205, whether the break switch 9 is depressed during the image playback in S203 is judged. When the break switch 9 has been depressed, the step proceeds to S206. When the break switch 9 has not been depressed, the condition in S203 is continued.

In S206, the image playback portion 20 suspends the playing of the recording medium D. Hence, the image is suspended at one scene and so is the playback of sounds. Also, the CPU 100 issues a command to the time measuring portion 194 to measure a suspend time according to a signal obtained when the break switch 9 is depressed. The time measuring data thus measured is saved successively in the RAM 103.

In S207, the image data 112 of the guiding image in the data storage portion 111 in the ROM 101 or the EEPROM 102 is read out, and the image suspended by the image playback portion 20 is switched to the image data 112 of the guiding image to be displayed. In this instance, the light emitting portion 9a provided in close proximity to the break switch 9 in the manipulation portion 5 lights ON or flashes. In this case, the CPU 100 may cause the light emitting portion 9a to flash in such a manner that the flashing is in sync with the playback rhythm of the sound data 113.

Also, at least one of the indirect lighting portion 68 and the ceiling lighting portion 55 provided to the image playback portion 20 and the projection portion 3, respectively, lights ON. The sound data 113 in the data storage portion 111 in the ROM 101 or the EEPROM 102 is read out, and the sound data 113 is provided to the sound control portion 115 to be output from the speakers 116 as sounds.

In S208, the image playback resuming image is returned to an image earlier than the suspend image. How long the image playback resuming image needs to be returned to reach an earlier image, from which the image playback is to be resumed, is pre-set as a return time in the program in the ROM 101 or the EEPROM 102. The return time is, for example, one minute or so. The CPU 100 subtracts the return time from the elapse time data, measured by the image playback time measuring portion 155 in the image playback portion 20 and saved in the elapse time buffer 156 in the RAM 103, and moves the position of the laser pick-up portion 153 on the recording medium D in the read portion 150 of the image playback portion 20 by a distance equivalent to the return time, to be maintained in the stand-by condition.

In S209, whether the break switch 9 is depressed again is judged. When the break switch 9 has been depressed again, the display of the guiding image in S207, the lighting or flashing of the light emitting portion 9a provided in close proximity to the break switch 9, lighting of the indirect lighting portion 68 or the ceiling lighting portion 55, and the sounds from the speakers 116 are all stopped, and the step proceeds to S210. When the break switch 9 has not been depressed again, the condition in S208 is continued.

In S210, the notifying image is displayed. The CPU 100 reads out the data of the notifying image 86 (shown in FIG. 5) pre-stored in the ROM 101 or the EEPROM 102, and switches the display from the guiding image 70 being display up to this moment to the notifying image 86. A time to display the switched notifying image 86 is pre-set in the program, and it is, for example, five seconds. Also, when the relatively bright guiding image 70 serving as the room light is switched to the notifying image 86, the notifying image 86 is changed to gradually lower the brightness or color saturation over five seconds specified above. The step proceeds to S211 when the time to display the notifying image 86 ends.

In S211, the image is return to the suspended image, to which the image has been returned by the return time in S208, and the step proceeds to S203 to resume the image playback by the image playback portion 20.

In S212, whether the suspend time exceeds the predetermined suspend time is judged. When the time measuring data, measured by the time measuring portion 194 and saved successively in the RAM 103, exceeds the predetermined suspend time, the display of the guiding image, lighting or flashing of the light emitting portion 9a provided in close proximity to the break switch 9, lighting of the indirect lighting portion 68 and the ceiling lighting portion 55, and the sounds from the speakers 116 are all stopped, and the step proceeds to S213. When the time measuring data as to the suspension has not exceeded the predetermined suspend time, the condition in S208 is continued.

In S213, the image playback portion 20 is stopped. The CPU 100 thus erases the data related to the image playback time measuring portion 155 and the time measuring portion 194 saved in the RAM 103.

In S214, the light source portion 190 in the projection portion 3 is stopped.

In S215, the optical cooling portion 192 is stopped.

In S216, the projection portion 3 is stopped.

In this manner, various operations are achieved by the CPU 100 serving as the control portion, together with the ROM 101, the EEPROM 102, and the RAM 103.

This exemplary embodiment described a case where the image playback portion 20 suspends the playback of images when the break switch 9 is depressed. It should be appreciated, however, that this exemplary embodiment is applicable as well when the image playback portion 20 stops the playback of images when the break switch 9 is depressed.

In the following, the advantages of the first exemplary embodiment will be described.

(1) When a manipulation to suspend the playback is performed by depressing the break switch 9 in the manipulation portion 5 while the recording medium D is being played, the guiding image 70 indicating a suspended condition is projected from the projection portion 3. The viewer is thus able to take a break comfortably without having to see the suspended image from the recording medium D throughout the break. Also, because the playback is suspended and the image automatically switches to the guiding image 70 by merely depressing the break switch 9, it is remarkably easy for the viewer to take a break while he is watching a movie or the like.

(2) By projecting the guiding image 70 at the predetermined brightness or color saturation to serve also as the lighting, the viewer is able to take a break without having to increase the brightness of the lighting of the room where he is watching a movie or the like
(3) By changing the conditions of the text or the picture displayed in the guiding image 70, it is possible to notify the viewer taking a break that the image playback portion 20 is not suspended due to a trouble or the like.

(4) By outputting predetermined sounds from the speakers 116 while the guiding image 70 is projected, the viewer is able to take a break comfortably.

(5) By including a text or a picture instructing the procedure to resume the playback by the image playback portion 20 in the guiding image 70, the viewer is able to resume the playback in a reliable manner when he is going to resume the playback of a movie or the like after the break.

(6) By causing the light emitting portion 9a in close proximity to the break switch 9 to light ON or flash when the suspend signal is provided in response to the depressing of the break switch 9, the viewer is able to confirm the position of the break switch 9 in a dimly lit room, and is thereby able to perform manipulations exactly when resuming the playback.

(7) By causing at least one of the ceiling lighting portion 55 in the projection portion 3 and the indirect lighting portion 68 in the image playback portion 20 to emit light when the suspend signal is provided in response to the depressing of the break switch 9, the viewer becomes able to take a break without having to turn on the light of the room where he is watching a movie or the like.

(8) By depressing the break switch 9 in the manipulation portion 5 again during a suspended condition, the image playback by the image playback portion 20 is resumed and the guiding image 70 being projected from the projection portion 3 is switched to a played back image of the image playback portion 20. The viewer is thus able to resume the viewing of a movie or the like after the break.

(9) When the playback resume signal is provided by depressing the break switch 9 again during the suspended condition, the image playback portion 20 resumes the image playback from an image at least earlier than the suspended image. The viewer is thus able to recall the story of the movie or the like before the break, and is thereby naturally able to continue to watch the rest of the movie or the like.

(10) By not only stopping the image playback portion 20 from a suspended condition, but also turning OFF the light source portion 190 of the projector when the time measured by the time measuring portion 194 exceeds the predetermined time, and further, by stopping the optical cooling portion 192 after the predetermined time, it is possible to reduce or prevent heat-induced deterioration of the optical system members, such as the liquid crystal panels 65a, 65b, and 65c, as well as to make a contribution to the power saving.

(11) Because the projection portion main body 2 is provided on the top surface of the image playback portion main body 50 in a manner so as to be allowed to tilt, and the projector 1 is placed on the table or the like, the projection portion 3 is allowed to move forward and backward and from side to side or rotate when an image is projected on the screen S or the like. The settings, therefore, become easier.

(12) Because the projection portion main body 2 is provided on the top surface of the image playback portion main body 50 in a manner so as to be allowed to tilt, and the manipulation portion 5 is provided to the projection portion main body 2, it is easy to manipulate the projection portion 3 and the image playback portion 20.

Second Exemplary Embodiment

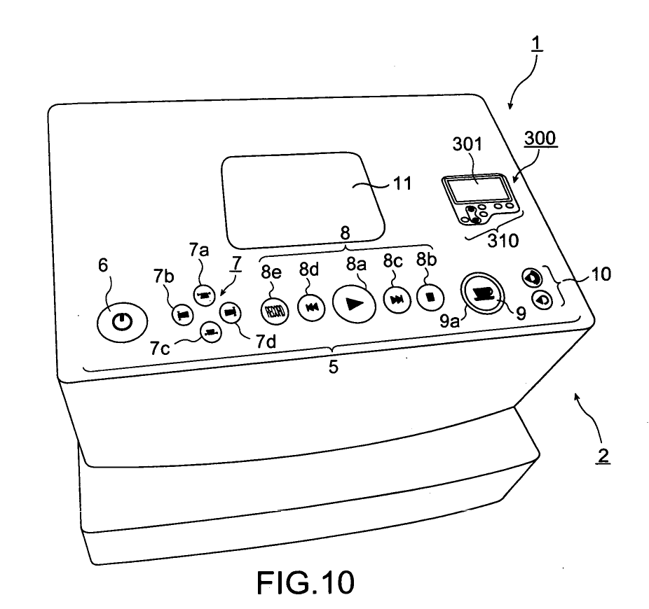

A second exemplary embodiment will now be described with reference to FIG. 10 through FIG. 12.

In this exemplary embodiment, data of the guiding image or data of sounds generated in an outside device or the like is stored in the projector to enable the stored data of the guiding image or sounds to be selected, so that the selected guiding image or sounds can be used when the playback is suspended. Hereinafter, only the differences from the first exemplary embodiment will be described.

FIG. 10 is a schematic of a projector. On the top surface of the projection portion main body 2 in the projector 1 is provided a display portion 300 including a display screen 301, such as a liquid crystal panel, a display processing portion, etc. The display portion 300 includes a display manipulation portion 310, which is furnished with a function of selecting and determining data to be displayed on the display screen 301, etc.

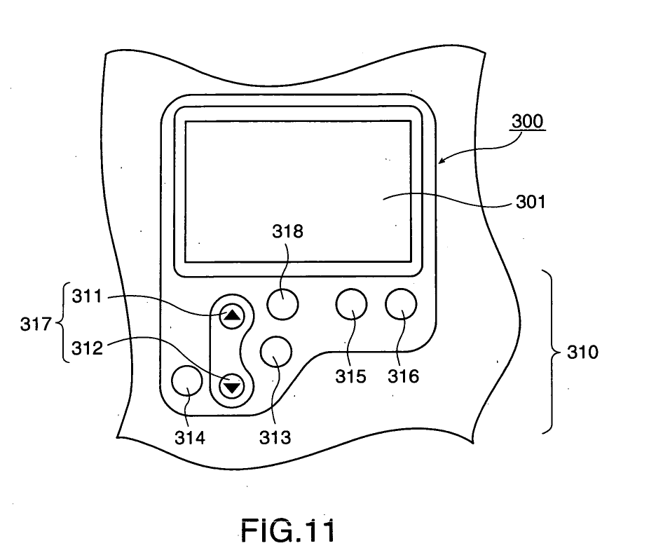

FIG. 11 is a schematic of the display portion. The display portion 300 includes the display screen 301 and the display manipulation portion 310. The display manipulation portion 310 includes a selection switch 317 including an upper selection switch 311 and a lower selection switch 312, an enter switch 313, a cancel switch 314, an image data display switch 315, and a sound data display switch 316.

On the display screen 301 are displayed data names of image data or sound data to enable desired data to be selected by moving a cursor on the display screen 301 with the use of the selection switch 317. When the selected data is determined, data is determined by depressing the enter switch 313. To cancel the data determined at this point, the cancel switch 314 is depressed, whereupon the data is cancelled and the display is returned to the data selection screen. When the image data display switch 315 is depressed, data names of the image data stored in the projector 1 are displayed on the display screen 301. When the sound data display switch 316 is depressed, data names of sound data stored in the projector 1 are displayed on the display screen 301.

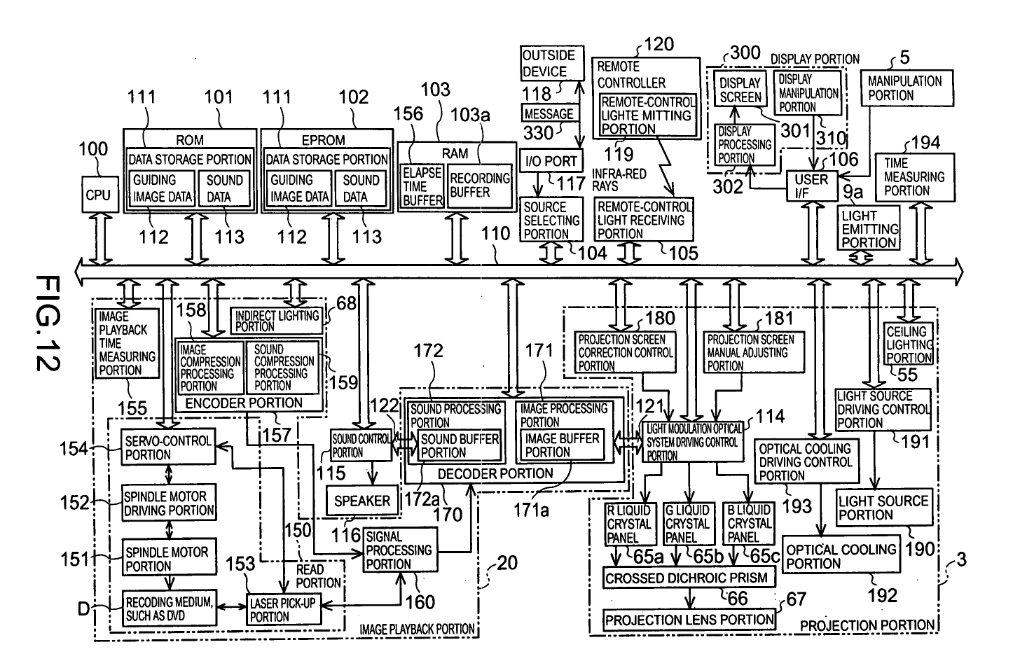

FIG. 12 is a schematic showing the electric configuration of the projector of this exemplary embodiment.

The projector 1 includes a CPU (Central Processing Unit) 100 serving as a control portion, a ROM (Read Only Memory) 101, an EEPROM (Electrically Erasable Programmable Read Only Memory) 102, and a RAM (Random Access Memory) 103. Also, it includes at least a source selecting portion 104, a user I/F 106, an image playback portion 20, a projection portion 3, and a sound control portion 107, all of which are electrically interconnected through a data bus 110.

The source selecting portion 104 establishes a connection to an outside device 118 serving as an image generating device, for example, a PC (Personal Computer), via an I/O port 117. When the source selecting portion 104 receives image data or sound data including a text or a picture generated in the outside device 118, the CPU 100 sends the image data to a light modulation optical system driving control portion 114. The image data is then modulated according to image information for respective beams of color light by three light modulation devices using an R (red) liquid crystal panel 65a, a G (green) liquid crystal panel 65b, and a B (blue) liquid crystal panel 65c, respectively. Image-modulated respective beams of color light are synthesized in a crossed dichroic prism 66, and a color image is scaled up and projected by a projection lens portion 67. The CPU 100 sends the sound data to a sound control portion 115, in which the sound data thus sent is subjected to the processing, such as amplification, to be converted to sound signals, which are sent to a plurality of speakers 116 for the viewer to hear them as sounds.

Also, a guiding image 70 generated in the outside device 118 can be stored in the projector 1. In this case, this data needs to be distinguished from data to be merely projected from the projection portion 3. In this exemplary embodiment, protocols according to which data is transmitted among computers are stored in the ROM 101 or the EEPROM 102, and data, therefore, can be transmitted to/from the outside device 118, such as a PC, within the stored protocols. When the source selecting portion 104 receives data from the outside device 118, such as a PC, via the I/O port 117, a message 330 stored in the data storage portion 111 in the ROM 101 or the EEPROM 102 is sent to the outside device 118, such as a PC. The message 330 is to inquire whether the data sent from the outside device 118, such as a PC, is “data to be merely projected from the projection portion 3” or “data of the guiding image 70”. In response to this inquiry, the outside device 118, such as a PC, is able to send a replay to the projector 1. When the reply from the outside device 118, such as a PC, is “data to be merely projected from the projection portion 3”, the CPU 100 sends the data to the light modulation optical system driving control portion 114 to project an image on the screen S or the like. When the replay from the outside device 118, such as a PC, is “data of the guiding image 70”, the CPU 100 adds a file name to the data of the guiding image 70 and stores the data in the data storage portion 111 in the EEPROM 102.

Likewise, when the data sent from the outside device 118, such as a PC, is data of sounds, data is transmitted between the projector 1 and the outside device 118. In the case of sound data to be outputted while the image playback portion 20 is suspended, a file name is added to the data and the data is stored in the data storage portion 111 in the EEPROM 102.

The file names of the data of the guiding image 70 and the sound data stored in the EEPROM 102 are sent to the display processing portion 302 via the user I/F 106. The data to be displayed as the guiding image 70 can be selected with the use of the image data display switch 315 (switches referred to hereinafter are shown in FIG. 11) or the sound data display switch 316 provided in the display manipulation portion 310. For example, when the image data display switch 315 is depressed, the data names of the guiding images 70 stored in the EEPROM 102 are displayed on the display screen 301. The cursor displayed on the display screen 301 is moved by depressing the selection switch 317 to select the desired file, and then the enter switch 313 is depressed. Upon receipt of a signal obtained when the enter switch 313 is depressed, the CPU 100 changes the data in the data storage portion 111 in the EEPROM 102 to the data determined by the enter switch 313 for the guiding image 70 to be projected from the projection portion 3 while the image playback portion 20 is suspended. Likewise, in the case of sound data, the CPU 100 changes the data in the storage portion 111 in the EEPROM 102 to the data determined by the enter switch 313.

In a case where the playback time for the data of the guiding image 70 or the sound data generated in the outside device 118, such as a PC, which is used while the image playback portion 20 is suspended, ends before the break switch 9 in the manipulation portion 5 is depressed, the data can be played back repetitively in succession.

Also, when the viewer wishes to know the image or sounds in a file, he moves the cursor to the file with the use of the selection switch 317 on the display screen 301, and depresses the display switch 318. When the depressed data is the image data, a low-resolution image is displayed as a thumbnail image for the viewer to know the contents of the guiding image 70 being selected by the cursor. In a case where the data being selected by the cursor is the sound data, when the viewer depresses the display switch 318, the CPU 100 reads out the selected sound data from the data storage portion 111 in the EEPROM 102. The CPU 100 sends the data thus read out to the sound control portion 115, and the speakers 116 then output sounds for the viewer to hear the contents of the selected sound data.

In a case where data sent from the outside device 118, such as a PC, is the data to be projected from the projection portion 3, and the viewer wishes to project the data later by storing the data temporarily in the projector 1, he stores the data in the EEPROM 102 by adding a name to the data, or he depresses the recording switch 8e (shown in FIG. 2) in the manipulation portion 5 to record the data in the recording medium D. The name of the data stored in stored in the EEPROM 102 or the recording medium D is displayed on the display screen 301, and the viewer is able to select the data stored in the EEPROM 102 or the recording medium D by manipulating the display manipulation portion 310 to use the image or the sounds by playing it back to be projected.

The advantages of the second exemplary embodiment will now be described.

(13) When the break switch 9 in the manipulation portion 5 is manipulated, the CPU 100 suspends the image playback portion 20 with a suspend signal obtained by this manipulation and reads out the image data of the guiding image 70 including the text or the picture selected through the display manipulation portion 310 from the data storage portion 111. The guiding image 70 according to the image data is thus projected from the projection portion 3. Hence, the viewer is able to select the guiding image 70 of his taste among the guiding images 70 prepared in the projector 1 in advance and enjoy the selected guiding image 70 during the break.

(14) Besides the guiding image 70 prepared in advance in the projector 1, sound data or image data used as the guiding image 70, generated in the outside device 118 serving as an image generating device, is stored in the data storage portion 111 to be displayed on the display screen 301. The viewer is thus able to select the guiding image 70 of his taste on the display screen by manipulating the display manipulation portion 310 in making a selection from the guiding image 70 or sound data he has stored by himself in addition to the guiding image 70 prepared in advance in the projector 1. The viewer is thus able to enjoy the guiding image 70 or sounds of his taste during the break.

(15) When the break switch 9 in the manipulation portion 5 is manipulated, the CPU 100 suspends the image playback portion 20 with a suspend signal obtained by this manipulation and reads out sound data selected through the display manipulation portion 310 from the data storage portion 111. Sounds according to the sound data are thus outputted from the speakers 116. Hence, the viewer is able to enjoy sounds of his taste, selected from the sounds prepared in advance in the projector 1, during the break.

(16) While the guiding image 70 is projected from the projector 3, sounds (predetermined sounds) stored in the data storage portion 111 are outputted from the speakers 116, while the light emitting portion 9a provided to the manipulation portion 5 is flashed in sync with the sounds, which provides the viewer with a change of pace. Also, when the room is dimly lit, the position of the break switch 9 used to resume the playback is notified clearly to the viewer, and he is therefore able to end the break easily.

(17) Because the brightness or the color saturation of the lighting by the indirect lighting portion 68 and the ceiling lighting portion 55 are changed, it is possible to notify the viewer that a break is being taken presently. It is also possible to notify the viewer that the image playback portion 20 is not stopped due to trouble but is suspended.

(18) When the break switch 9 in the manipulation portion 5 is manipulated to resume the playback, the lighting by the indirect lighting portion 68 and the ceiling lighting portion 55 to emit light from a portion other than the projection lens portion is lowered step by step to the predetermined low brightness. Hence, because the bright guiding image 70 is not abruptly switched to a dark playback image, the viewer's eyes can adjust to the darkness in a natural manner.

(19) Before the playback is resumed through manipulation on the break switch 9 in the manipulation portion 5, the guiding image 70 being projected from the projection portion 3 is switched to the notifying image 86 notifying that the playback by the image playback portion 20 is to be resumed, it is possible to notify the viewer of the resumption of the playback.

Modifications of the First Exemplary Embodiment and the Second Exemplary Embodiment

It should be appreciated that the exemplary embodiments are not limited to the descriptions above, and can be changed as follows.

First Modification

In a case where the image playback by the image playback portion is resumed through a manipulation on the manipulation portion to resume the playback, the guiding image 70 may be switched to the playback image of the image playback portion after the guiding image at the predetermined brightness, serving also as the pre-set lighting, is darkened gradually, and the image playback portion may resume the image playback from an image at least earlier than the suspended image.

Second Modification

The image playback resuming image is returned to an image earlier than the suspended image in S208 of FIG. 9; however, the same can be performed after S210.

Third Modification

The suspended image may be used as part of the guiding image displayed when the break switch 9 is depressed while a DVD is being played. In this case, the image data at the time of suspension, which is saved in the RAM 103, is used. Hence, the image will not be disturbed when the position of the laser pick-up portion 153 is moved by a distance corresponding to the return time to be maintained in the stand-by condition for the image playback portion to resume the playback. In a case where the suspended image is used as the background of the guiding image, the brightness, color saturation, and hue of the background are not necessarily the same as those of the suspended image data. Alternatively, the suspended image may be scaled down to be aligned and displayed with the picture indicating the break or the like.

Fourth Modification

In S205 of FIG. 9, in a case where an elapse time since the break switch 9 has been depressed exceeds the allowance break time pre-set in the program, the playback by the image playback portion 20 may be resumed. Also, a remaining time until the resumption of the playback by the image playback portion 20 according to the allowance break time may be projected as part of the guiding image 70.

The technical ideas understood from the exemplary embodiments and modifications above will now be described below.

The projector may further include a time measuring portion to measure a suspended time since the suspend signal has been provided. When a time measured by the time measuring portion exceeds a predetermined suspend time, the control portion not only stops the image playback portion from a suspended condition, but also turns OFF a light source portion of the projector, and further stops an optical cooling portion after a predetermined time.

The projector may further include a display manipulation portion to select the text or the picture included in the guiding image to be projected from the projection portion while the image playback portion is stopped. When the stop signal is provided, the control portion reads out the image data of the guiding image including the text or the picture selected through the display manipulation portion from the data storage portion. The guiding image according to the image data is thus projected from the projection portion.

The projector may further include a data storage portion to read in image data generated in an image generating device to be stored as image data of the guiding image; and a display manipulation portion to select the guiding image to be projected from the projection portion while the image playback portion is stopped. When the stop signal is provided, the control portion reads out from the data storage portion either the image data of the guiding image or the image data generated in the image data generating device, whichever is selected through the display manipulation portion, and enables the guiding image according to the image data to be projected from the projection portion.

The projector may further include a data storage portion to store sound data indicting that the image playback is stopped; and a sound selection manipulating portion to select a predetermined sound to be outputted from the speaker while the image playback portion is stopped. When the stop signal is provided, the control portion reads out the predetermined sound selected through the sound selection manipulating portion from the data storage portion to enable sounds according to the sound data to be outputted from the speaker.

The projector may further include a data storage portion to read in sound data generated in a sound generating device as sound data to be output from the speaker as sounds while the guiding image is being projected from the projection portion; and a sound selection manipulation portion to select sounds to be output from the speaker while the image playback portion is stopped. When the stop signal is provided, the control portion reads out from the data storage portion either the sound data or the sound data generated in the sound generating device, whichever is selected through the sound selection manipulation portion, for sounds according to the sound data to be outputted from the speaker.

The projector may further include when the stop signal is provided, the control portion outputting the predetermined sounds from the speaker while the guiding image is being projected from the projection portion, and causes the light emitting portion in the manipulation portion to flash in sync with the sounds.

The projector may further include the control portion changing brightness or color saturation of lighting by the lighting portion.

The projector may further include the control portion gradually lowering lighting of the lighting portion that emits light from a portion other than the projection lens portion to predetermined low brightness, according to the playback start signal.

The projector may further include the control portion switching the guiding image being projected from the projection portion to a notifying image to notify that the image playback portion is to start the playback, according to the playback start signal.

The projector may further include a projection portion main body being provided on a top surface of an image playback portion main body in a manner so as to be allowed to tilt.

The projector may further include a projection main body being provided on a top surface of an image playback portion main body in a manner so as to be allowed to tilt, and the manipulation portion is provided to the projection portion main body.

The projector may further include the manipulation portion being a break switch exclusively used to take a break, provided apart from a stop switch to stop the playback by the image playback portion.

1. A projector, that plays back an image recorded in a recording medium comprising:
an image playback portion to play back the image recorded in the recording medium;
a projection portion to project the image played back by the image playback portion;
a manipulation portion to stop or start image playback by the image playback portion;
a data storage portion to store image data of a guiding image indicating that the image playback is stopped; and
a control portion to stop the image playback by the image playback portion according to a stop signal provided when the manipulation portion is manipulated, and to project the guiding image, indicating a stopped condition, from the projection portion according to the image data read out from the data storage portion.

2. The projector according to claim 1,
the control portion projecting the guiding image at a predetermined brightness to serve also as pre-set lighting.

3. The projector according to claim 1,
the guiding image including a text or a picture indicating the stopped condition;
more than one item of moving picture data to change conditions of the text or the picture being stored in the data storage portion; and
the control portion projecting the guiding image from the projection portion, by changing the conditions of the text or the picture according to the moving picture data read out from the data storage portion.

4. The projector according to claim 1, further comprising:
a speaker,
the control portion outputting predetermined sounds from the speaker while the guiding image is being projected from the projection portion.

5. The projector according to claim 1,
the guiding image including a text or a picture to instruct a procedure to start the playback by the image playback portion.

6. The projector according to claim 1,
the manipulation portion including a light emitting portion; and
the control portion causing the light emitting portion in the manipulation portion to light ON or flash when the stop signal is provided.

7. The projector according to claim 1, further comprising:
a lighting portion to emit light from a portion other than a projection lens portion of the projection portion,
the control portion causing the lighting portion to emit light when the stop signal is provided.

8. The projector according to claim 1,
when a playback start signal is provided by a manipulation on the manipulation portion, the control portion causes the image playback portion to start the image playback, and switches the guiding image being projected from the projection portion to a playback image of the image playback portion.

9. The projector according to claim 8,
when the playback start signal is provided, the control portion causes the image playback portion to start the image playback from an image at least earlier than an image when the image playback was stopped.
